(19) United States
(12) Patent Application Publication
(10) Pub. No.: US 2008/0231651 A1
(43) Pub. Date: Sep. 25, 2008

(54) INK LEVEL DETECTING APPARATUS OF INK-JET IMAGE FORMING APPARATUS AND METHOD FOR CONTROLLING THE SAME

(75) Inventor: Dong Kee JUNG, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/042,583

(22) Filed: Mar. 5, 2008

(30) Foreign Application Priority Data
Mar. 21, 2007 (KR) 2007-27730

(51) Int. Cl. B41J 29/393

(52) U.S. Cl. 347/19

(57) ABSTRACT

An ink level detecting apparatus of an ink-jet image forming apparatus includes a switching part which is switched on and off by an input signal, an ink detecting part which is turned on and off according to a switching operation of the switching part to detect an ink level of ink in the ink-jet image forming apparatus, and a controller which checks a voltage between the ink and the ink detecting part before a saturation period of the ink detecting part in order to detect the ink level, based on whether the ink detecting part is turned on.

### CROSS-REFERENCE TO RELATED APPLICATION

This application claims the benefit of Korean Application No. 2007-27730, filed Mar. 21, 2007 in the Korean Intellectual Property Office, the disclosure of which is incorporated herein by reference.

### BACKGROUND OF THE INVENTION

1. Field of the Invention

Aspects of the present invention relate to an ink-jet image forming apparatus. More particularly, aspects of the present invention relate to an ink level detecting apparatus of an ink-jet image forming apparatus and a method for controlling the same, capable of rapidly detecting the level of ink remaining in an ink tank by checking voltage before the saturation period.

2. Description of the Related Art

In general, ink-jet image forming apparatuses discharge ink through an ink-jet head to form images. Examples of ink-jet image forming apparatuses include a copy machine, a facsimile, and a multifunctional peripheral (MFP) employing an ink-jet printing scheme, as well as a printer, which is a peripheral device of a computer.

The ink-jet image forming apparatus receives ink from an ink tank called an ink cartridge or an ink container. The ink in the ink tank may be directly supplied to the ink-jet head. In addition, the ink may be supplied to the ink-jet head through a predetermined ink supplying path. Then, the ink is sprayed onto a printing medium, such as paper, according to a printing signal.

As ink is exhausted through the above procedure, the level of the ink in the ink tank is lowered. Eventually, the ink level arrives at the lowest level. In this case, the ink tank should be refilled with ink, or replaced with a new ink tank filled with ink.

FIG. 1 is view showing the structure of a typical ink level detecting apparatus. FIG. 2 is a circuit diagram showing the ink level detecting apparatus shown in FIG. 1. FIG. 3 is a graph showing voltage levels measured using the circuit of the ink level detecting apparatus shown in FIG. 2.

As shown in FIG. 1, an ink tank 10 includes two sensing pins 20a and 20b to detect the level of ink. Ink is an electric conductor that enables current to flow therethrough. In the ink tank 10 shown in FIG. 1, one sensing pin 20a is connected to an input voltage side and the other sensing pin 20b is connected to the ground side. Accordingly, existence of the ink can be determined based on the current conduction through the ink.

Hereinafter, details regarding the operational procedure of the typical ink level detecting apparatus will be described with reference to FIG. 2. If low-level voltage is supplied to a switching part 30 in order to check the ink level, the switching part 30 is turned off, so that input voltage output from a power supply is supplied to the ink tank 10.

If ink exists at levels corresponding to both the sensing pins 20a and 20b, i.e., if the ink is high enough to reach a level of the sensing pin 20a, the ink conducts a current through the sensing pins 20a and 20b, and the input voltage is supplied through the sensing pins 20a and 20b. The supplied input voltage arrives at a saturation point beyond a predetermined threshold voltage. At the saturation point where at least 70% of the input voltage is supplied, the ink level can be detected.

As shown in FIG. 3, since ink has resistor and capacitor characteristics, a rising time and a falling time of the supplied voltage exists at the high point according to the method for detecting an ink level as described above. Accordingly, when taking both the rising time and the falling time into consideration, the time required for the voltage to reach the predetermined threshold voltage (which is a maximum time of several seconds (secs) and a minimum time of several hundred milli-seconds (msecs)) may be delayed during the checking of the ink tank the ink-jet image forming apparatus.

In other words, such delay time serves as an undesired characteristic of the conventional ink level detecting apparatus when the ink level is detected. When the ink level is checked each time a sheet of paper is printed, the delay time becomes a more significant problem. Accordingly, there is a need to detect the ink levels more rapidly.

### SUMMARY OF THE INVENTION

Accordingly, an aspect of the present invention provides an ink level detecting apparatus of an ink-jet image forming apparatus and a method for controlling the same, capable of rapidly detecting the level of ink remaining in an ink tank.

Additional aspects and/or advantages of the invention will be set forth in part in the description which follows and, in part, will be apparent from the description, or may be learned by practice of the invention.

According to an aspect of the present invention, an ink level detecting apparatus of an ink-jet image forming apparatus includes a switching part which is switched on and off by an input signal, an ink detecting part which is turned on and off according to a switching operation of the switching part to detect an ink level of ink in the ink-jet image forming apparatus, and a controller which checks a voltage between the ink and the ink detecting part before a saturation period of the ink detecting part in order to detect the ink level, based on whether the ink detecting part is turned on.

According to an aspect of the present invention, the saturation period is delayed until an input voltage supplied to the ink detecting part through the switching part arrives at a predetermined saturation voltage.

According to an aspect of the present invention, the input signal is applied in order to detect the ink level for each printing medium used during a printing operation.

According to an aspect of the present invention, a plurality of the ink detecting parts are provided.

According to an aspect of the present invention, one end of the ink detecting part is connected to the switching part, and the ink detecting part comprises a pull-up resistor to maintain an input voltage supplied through the switching part at a predetermined voltage.

According to an aspect of the present invention, the ink level detecting apparatus further includes a filter part connected to the ink detecting part in parallel to remove noise from the voltage.

According to another aspect of the present invention, a method for controlling an ink level detecting apparatus of an ink-jet image forming apparatus includes performing a switching operation according to an input signal, checking a voltage between ink and an ink detecting part before a saturation period of the ink detecting part in order to detect an ink level of the ink, based on whether the ink detecting part is turned on according to the switching operation, and detecting the ink level using the checked voltage.

According to another aspect of the present invention, the method further includes delaying the saturation period until a supplied input voltage arrives at a predetermined saturation voltage, based on whether the ink detecting part is turned on according to the switching operation.

According to another aspect of the present invention, the method further includes applying the input signal is applied in order to detect the ink level for each printing medium used during a printing operation.

According to another aspect of the present invention, the method further includes maintaining a supplied input voltage at a predetermined voltage, based on whether the ink detecting part is turned on according to the switching operation.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing a typical ink level detecting apparatus;

FIG. 2 is a circuit diagram showing the ink level detecting apparatus shown in FIG. 1;

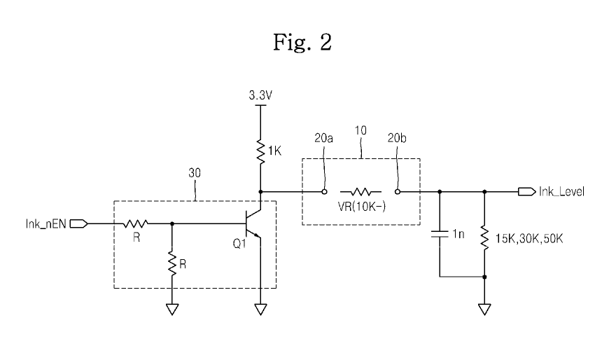

FIG. 3 is a graph showing voltage levels measured using the circuit of the ink level detecting apparatus shown in FIG. 2;

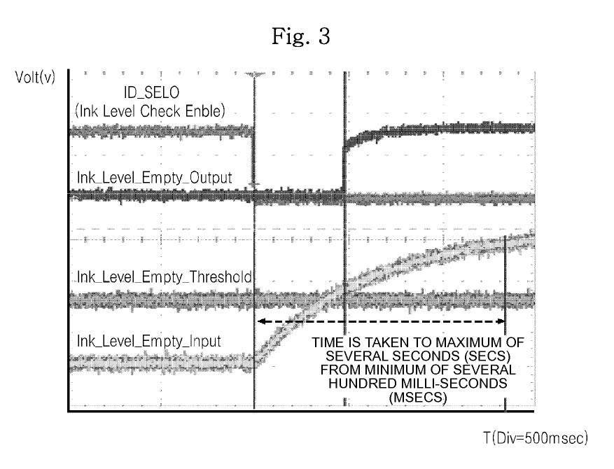

FIG. 4 is a circuit diagram showing an ink level detecting apparatus of an ink-jet image forming apparatus according to an embodiment of the present invention;

FIG. 5 is a graph showing voltage levels measured using the circuit of the ink level detecting apparatus of the ink-jet image forming apparatus shown in FIG. 4; and

FIG. 6 is a flowchart showing the control procedure of the ink level detecting apparatus of the ink-jet image forming apparatus according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

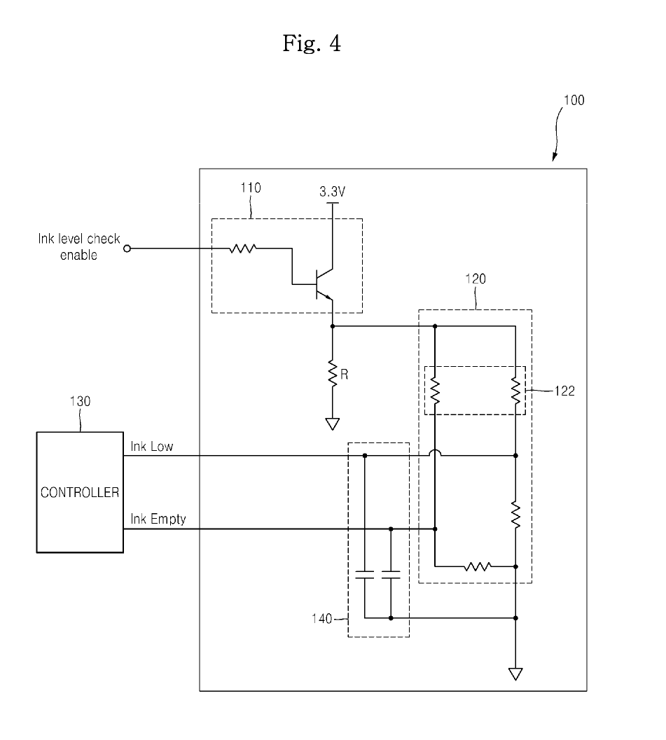

FIG. 4 is a circuit diagram showing an ink level detecting apparatus 100 of an ink-jet image forming apparatus according to an embodiment of the present invention. The ink level detecting apparatus 100 includes a switching part 110, an ink detecting part 120, and a controller 130. It is understood, however, that the ink level detecting apparatus 100 may also include a wide variety of other components in addition to those shown in FIG. 4 and described above, such as openings, supply paths, other types of sensors, and the like.

The switching part 110 performs a switching operation according to an input signal applied from an exterior source, and may be applied in a variety of ways. According to an aspect of the present invention, the input signal is applied such that an ink level is detected each time a page of printing media, such as sheets of paper, sheets of recycled paper, overhead transparency sheets, stationary, etc., is printed thereto during a printing operation.

The exterior source used to supply the input signal may be applied from a variety of sources in a variety of ways. For example, the input signal may be applied from a micro-computer in order to detect the ink level before a printing operation is started. In addition, the input signal may be applied to detect the ink level before the next page of printing media is printed after the first page is printed. In addition, the input signal may be applied when a user inputs a command signal used to detect the ink level.

Preferably, the switching part 110 includes a transistor. According to an aspect of the present invention, the switching part 110 includes an NPN transistor, however, it is understood that the switching part 110 is not limited thereto, and may instead include other types of transistors, such as PNP transistors, etc. When a high-level input signal is applied, the switching part 110 is switched on, so that an input voltage is supplied to the switching part 110. Then, the ink detecting part 120 is turned on or off according to the switching operation of the switching part 110 to detect the ink level.

According to an aspect of the present invention, a plurality of ink detecting parts 120 may be disposed in the ink level detecting apparatus 100. However, it is understood that aspects of the present invention are not limited to having a plurality of ink detecting parts 120, and may instead employ a single ink detecting part 120.

In detail, when the switching part 110 is embodied as an NPN transistor, if the high-level input signal is applied, the switching part 110 is turned on, so that the input voltage is supplied to the switching part 110. If the input voltage is input to the switching part 110, the ink detecting part 120 is turned on, so that the ink level can be detected.

Hereinafter, the procedure of detecting the ink level will be described in detail. According to an aspect of the present invention, the ink tank includes a low-level ink detecting part for “Ink Low” and an empty-level ink detecting part for “Ink Empty” in order to detect the ink level, and the low-level ink detecting part is higher than the empty-level ink detecting part. The low-level and empty-level ink detecting parts are connected between the input voltage side and the ground side, respectively, as shown in FIG. 4. If the ink level is at a height between the low-level ink detecting part and the empty-level ink detecting part, current flows to the empty-level ink detecting part, at which ink exists, instead of the low-level ink detecting part, at which ink does not exist, based on an ink characteristic. In this state, the ink level represents a low state.

When the ink level is at a height below the empty-level ink detecting part, the ink is not in contact with either the low-level ink detecting part or the empty-level ink detecting part. Accordingly, when the ink level is a height below the empty-level ink detecting part, current does not flow to either the empty-level ink detecting part or the low-level ink detecting part. In this state, the ink level represents an empty state. It is understood that the ink detecting part 120 is not limited to having only the low-level ink detecting part and the empty-level ink detecting part in all aspects, and may instead have only one ink detecting part, or many different ink detecting parts, for example, “empty,” “low,” “medium,” and “high” ink detecting parts.

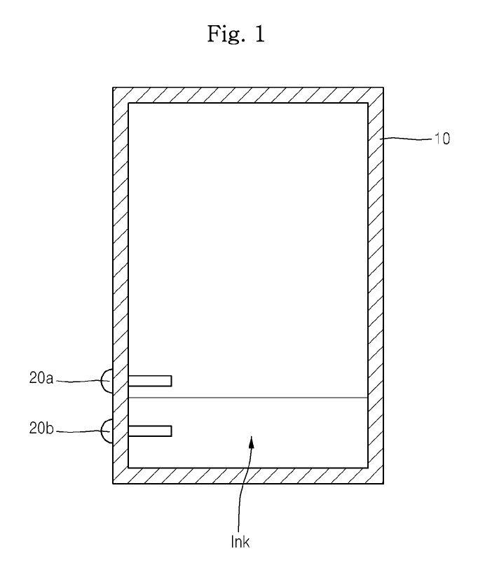

Consequently, the ink tank according to an aspect of the present invention includes a plurality of ink detecting parts as described above. Accordingly, the ink level can be detected according to the flow state of current to the ink detecting parts. While not limited thereto, the ink detecting part 120 may detect the current and voltage using a sensing pin, such as the sensing pins 20a and 20b shown in FIG. 1.

According to an aspect of the present invention, one end of the ink detecting part 120 is connected to the switching part 110, and the ink detecting part 120 includes a pull-up resistor 122 to maintain the input voltage supplied through the switching part 110 to a predetermined voltage. In other words, the pull-up resistor 122 is installed in the ink tank to check the short state, that is, an ink empty state, and then a voltage level is checked in the pull-up resistor 122.

Further, if ink does not exist in the ink tank, the supplied input voltage is insufficient. As a result, an erroneous operation may occur. Accordingly, the pull-up resistor 122 is installed in order to prevent the erroneous operation from occurring. It is understood, however, that components other than a pull-up resistor 122 may instead be used, such as other logic circuits configured to maintain voltage levels.

The ink level detecting apparatus 100 according to aspects of the present invention further includes a filter part 140 connected to the ink detecting part 120 in parallel. The filter part 140 is configured to filter the voltage supplied to the ink detecting part 120 to remove noise, and may be embodied as a low-pass filter, a high-pass filter, a bandpass filter, etc.

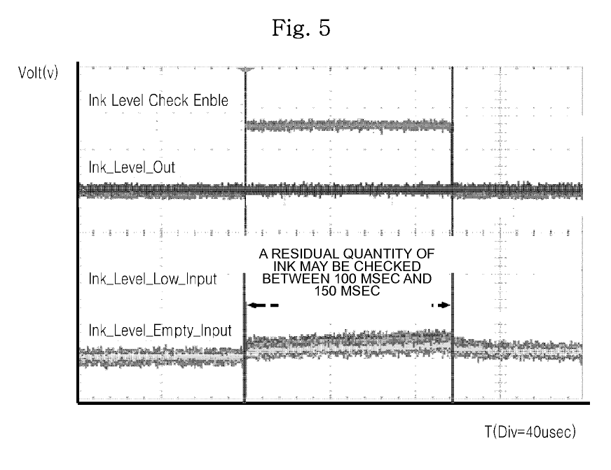

FIG. 5 is a graph showing voltage levels measured using the circuit of the ink level detecting apparatus 100 of the ink-jet image forming apparatus shown in FIG. 4. As shown in FIG. 5, when the ink detecting part 120 is turned on, the controller 130 checks a voltage before a saturation period of the ink detecting part 120 in order to detect the ink level. According to an aspect of the present invention, the saturation period is delayed until the input voltage supplied to the ink detecting part 120 through the switching part 110 reaches a predetermined saturation voltage.

In other words, even if voltage is supplied to the ink cartridge, the time required for the voltage to reach the predetermined saturation voltage (which is a maximum of several seconds and a minimum of several hundred milli-seconds) may be delayed until the voltage reaches the saturation state due to the characteristics of ink. For this reason, the voltage level should be checked within a short time interval before the voltage level rises after the voltage is supplied. In this case, since the checked voltage level is within the low range of 100 mV to 200 mV in a normal state, the voltage level of a complementary metal-oxide-semiconductor (CMOS) is read. For example, a voltage above 2.5V indicates a high voltage corresponding to an ink level above a low level, and a voltage less than 2.5V indicates a low voltage corresponding to an ink level below a low level. Since the controller 130 checks the voltage level to detect the ink level within a short time interval as described above, the input signal can be applied to the switching part 110 in several hundred micro-seconds or less. It is understood that aspects of the present invention are not limited to using 2.5V as the voltage level corresponding to the low ink level, and it is further understood that other types of semiconductors may also be used instead of a CMOS.

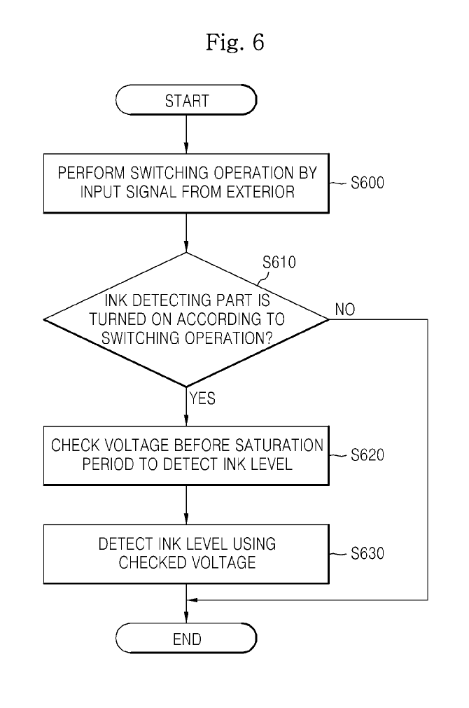

Hereinafter, the control procedure of the ink level detecting apparatus 100 of the ink-jet image forming apparatus will be described. FIG. 6 is a flowchart showing the control procedure of the ink level detecting apparatus 100 of the ink-jet image forming apparatus according to an embodiment of the present invention. As shown in FIG. 6, the switching part is switched by the input signal applied from an exterior source at operation S600).

According to an aspect of the present invention, the input signal is applied such that an ink level is detected for each printing medium. Also, the input signal may be applied from a variety of different types of exterior sources, such as, for example, a micro-computer, in order to detect the ink level before a printing operation is started. In addition, the input signal may be applied to detect the ink level before a next page is printed after a first page is printed. It is understood that the input signal is not required to be applied to detect an ink level for each printing medium, and may instead be applied to detect an ink level for every other printing medium, for every third printing medium, for each printing operation, etc. In addition, the input signal may be applied when a user inputs a command signal used to detect the ink level.

Then, the state of the ink detecting part is determined according to a switching operation at operation S610. If the ink detecting part is in a turn-on state, a voltage is checked before a saturation period in order to detect the ink level at operation S620.

According to an aspect of the present invention, at operation S620, since the input voltage is supplied to the ink detecting part 120 in an unstable fashion, the control procedure is configured to further include an operation of maintaining the input voltage at a predetermined voltage. In this case, when the ink detecting part is turned on according to the switching operation at operation S610, the saturation period is delayed until the supplied input voltage reaches a predetermined saturation voltage.

Finally, the ink level is detected by using the checked voltage at operation S630. The ink level may be detected for each printing medium, for every other printing medium, for every third printing medium, at the beginning of each printing operation, etc. Based on the detected ink level, an input signal may be sent to the ink-jet image forming apparatus indicating whether to continue a printing operation.

As described above, in the ink level detecting apparatus 100 of the image forming apparatus and the method for controlling the same according to aspects of the present invention, a voltage is checked before a saturation period, so that the level of ink remaining in an ink tank can be rapidly detected. In addition, unlike the conventional technique, the voltage level can be directly checked without comparing the supplied voltage to a threshold voltage, so that the ink level can be detected in a more efficient fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An ink level detecting apparatus of an ink-jet image forming apparatus comprising:
an ink detecting part to detect an ink level of ink by detecting a voltage between the ink detecting part and the ink; and
a controller which checks the voltage before a saturation period of the ink detecting part in order to detect the ink level.

2. The ink level detecting apparatus as claimed in claim 1, further comprising a switching part which switches the ink detecting part on and off according to whether the switching part receives an input signal.

3. The ink level detecting apparatus as claimed in claim 2, wherein the input signal is applied in order to detect the ink level for each printing medium used during a printing operation.

4. The ink level detecting apparatus as claimed in claim 2, wherein the ink detecting part comprises a pull-up resistor to maintain an input voltage supplied through the switching part at a predetermined saturation voltage.

5. The ink level detecting apparatus as claimed in claim 2, further comprising a filter part connected to the ink detecting part to remove noise from the voltage.

6. The ink level detecting apparatus as claimed in claim 2, wherein the saturation period is delayed until the voltage, which is supplied to the ink detecting part through the switching part, reaches a predetermined saturation voltage.

7. A method for controlling an ink level detecting apparatus of an ink-jet image forming apparatus, the method comprising:
checking a voltage between an ink detecting part and ink before a saturation period of the ink detecting part; and
detecting an ink level of the ink based on the checked voltage.

8. The method as claimed in claim 7, further comprising switching the ink detecting part on and off according to whether an input signal is transmitted to the ink level detecting apparatus.

9. The method as claimed in claim 8, further comprising applying the input signal in order to detect the ink level for each printing medium used during a printing operation.

10. The method as claimed in claim 8, further comprising maintaining a supplied input voltage at a predetermined voltage level when the ink detecting part is turned on according to the switching operation.

11. The method as claimed in claim 8, further comprising maintaining a supplied input voltage at a predetermined voltage level based on whether the ink detecting part is turned on.

12. The method as claimed in claim 8, further comprising delaying the saturation period until a supplied input voltage arrives a predetermined saturation voltage, based on whether the ink detecting part is turned on according to the switching operation.
